(19) United States
(12) Patent Application Publication
(10) Pub. No.: US 2014/0143367 A1
(43) Pub. Date: May 22, 2014

(54) ROBUSTNESS IN A SCALABLE BLOCK STORAGE SYSTEM

(71) Applicant: Board of Regents, The University of Texas System, Austin, TX (US)

(72) Inventors: Michael D. Dahlin, Austin, TX (US); Lorenzo Alvisi, Austin, TX (US); Lakshmi Ganesh, Austin, TX (US); Mark Silberstein, Austin, TX (US); Yang Wang, Austin, TX (US); Manos Kapritsos, Austin, TX (US); Prince Mahajan, Austin, TX (US); Jeevitha Kirubanandam, Austin, TX (US); Zuocheng Ren, Austin, TX (US)

(73) Assignee: Board of Regents, The University of Texas System, Austin, TX (US)

(21) Appl. No.: 13/967,513

(22) Filed: Aug. 15, 2013

Related U.S. Application Data
(60) Provisional application No. 61/727,824, filed on Nov. 19, 2012.

(51) Int. Cl. G06F 15/173

(52) U.S. Cl. CPC G06F 15/17331
USPC 709/213

(57) ABSTRACT

A storage system that accomplishes both robustness and scalability. The storage system includes replicated region servers configured to handle computation involving blocks of data in a region. The storage system further includes storage nodes configured to store the blocks of data in the region, where each of the replicated region servers is associated with a particular storage node of the storage nodes. Each storage node is configured to validate that all of the replicated region servers are unanimous in updating the blocks of data in the region prior to updating the blocks of data in the region. In this manner, the storage system provides end-to-end correctness guarantees for read operations, strict ordering guarantees for write operations, and strong durability and availability guarantees despite a wide range of server failures (including memory corruptions, disk corruptions, etc.) and scales these guarantees to thousands of machines and tens of thousands of disks.

### CROSS-REFERENCE TO RELATED APPLICATIONS

This application is related to the following commonly owned co-pending U.S. Patent Application:

Provisional Application Ser. No. 61/727,824, “Scalable Reliable Storage System,” filed Nov. 19, 2012, and claims the benefit of its earlier filing date under 35 U.S.C. §119(e).

### TECHNICAL FIELD

The present invention relates generally to storage systems, such as cloud storage systems, and more particularly to a block storage system that is both robust and scalable.

### BACKGROUND

The primary directive of storage—not to lose data—is hard to carry out: disks and storage sub-systems can fail in unpredictable ways, and so can the processing units and memories of the nodes that are responsible for accessing the data. Concerns about robustness (ability of a system to cope with errors during execution or the ability of an algorithm to continue to operate despite abnormalities in input, calculations, etc.) become even more pressing in cloud storage systems, which appear to their clients as black boxes even as their larger size and complexity create greater opportunities for error and corruption.

Currently, storage systems, such as cloud storage systems, have provided end-to-end correctness guarantees on distributed storage despite arbitrary node failures, but these systems are not scalable as they require each correct node to process at least a majority of the updates. Conversely, scalable distributed storage systems typically protect some subsystems, such as disk storage, with redundant data and checksums, but fail to protect the entire path from a client write request (request to write data to the storage system) to a client read request (request to read data from the storage system), leaving them vulnerable to single points of failure that can cause data corruption or loss.

Hence, there is not currently a storage system, such as a cloud storage system, that accomplishes both robustness and scalability while providing end-to-end correctness guarantees.

### BRIEF SUMMARY

In one embodiment of the present invention, a storage system comprises a plurality of replicated region servers configured to handle computation involving blocks of data in a region. The storage system further comprises a plurality of storage nodes configured to store the blocks of data in the region, where each of the plurality of replicated region servers is associated with a particular storage node of the plurality of storage nodes. Each of the storage nodes is configured to validate that all of the plurality of replicated region servers are unanimous in updating the blocks of data in the region prior to updating the blocks of data in the region.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates a network system configured in accordance with an embodiment of the present invention;

FIG. 2 illustrates a cloud computing environment in accordance with an embodiment of the present invention;

FIG. 3 illustrates a schematic of a rack of compute nodes of the cloud computing node in accordance with an embodiment of the present invention;

FIG. 4 illustrates a hardware configuration of a compute node configured in accordance with an embodiment of the present invention;

FIG. 5 illustrates a schematic of a storage system that accomplishes both robustness and scalability in accordance with an embodiment of the present invention;

FIG. 6 illustrates the storage system's pipelined commit protocol for write requests in accordance with an embodiment of the present invention;

FIG. 7 depicts the steps to process a write request using active storage in accordance with an embodiment of the present invention;

FIG. 8 illustrates a volume tree and its region trees in accordance with an embodiment of the present invention; and

FIG. 9 illustrates the four phases of the recovery protocol in pseudocode in accordance with an embodiment of the present invention.

### DETAILED DESCRIPTION

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

While the following discusses the present invention in connection with a cloud storage system, it is to be understood that the principles of the present invention may be implemented in any type of storage system. A person of ordinary skill in the art would be capable of applying the principles of the present invention to such implementations. Further, embodiments applying the principles of the present invention to such implementations would fall within the scope of the present invention.

It is understood in advance that although this disclosure includes a detailed description on cloud computing, implementation of the teachings recited herein are not limited to a cloud computing environment. Rather, the embodiments of the present invention are capable of being implemented in conjunction with any type of clustered computing environment now known or later developed.

In any event, the following definitions have been derived from the “The NIST Definition of Cloud Computing” by Peter Mell and Timothy Grance, dated September 2011, which is cited on an Information Disclosure Statement filed herewith, and a copy of which is provided to the U.S. Patent and Trademark Office.

Cloud computing is a model for enabling ubiquitous, convenient, on-demand network access to a shared pool of configurable computing resources (e.g., networks, servers, storage, applications, and services) that can be rapidly provisioned and released with minimal management effort or service provider interaction. This cloud model is composed of five essential characteristics, three service models, and four deployment models.

Characteristics are as follows:

On-Demand Self-Service: A consumer can unilaterally provision computing capabilities, such as server time and network storage, as needed, automatically without requiring human interaction with each service's provider.

Broad Network Access: Capabilities are available over a network and accessed through standard mechanisms that promote use by heterogeneous thin or thick client platforms (e.g., mobile phones, tablets, laptops and workstations).

Resource Pooling: The provider's computing resources are pooled to serve multiple consumers using a multi-tenant model, with different physical and virtual resources dynamically assigned and reassigned according to consumer demand. There is a sense of location independence in that the consumer generally has no control or knowledge over the exact location of the provided resources but may be able to specify location at a higher level of abstraction (e.g., country, state or data center). Examples of resources include storage, processing, memory and network bandwidth.

Rapid Elasticity: Capabilities can be elastically provisioned and released, in some cases automatically, to scale rapidly outward and inward commensurate with demand. To the consumer, the capabilities available for provisioning often appear to be unlimited and can be purchased in any quantity at any time.

Measured Service: Cloud systems automatically control and optimize resource use by leveraging a metering capability at some level of abstraction appropriate to the type of service (e.g., storage, processing, bandwidth and active user accounts). Resource usage can be monitored, controlled and reported providing transparency for both the provider and consumer of the utilized service.

Service Models are as follows:

Software as a Service (SaaS): The capability provided to the consumer is to use the provider's applications running on a cloud infrastructure. The applications are accessible from various client devices through either a thin client interface, such as a web browser (e.g., web-based e-mail) or a program interface. The consumer does not manage or control the underlying cloud infrastructure including network, servers, operating systems, storage, or even individual application capabilities, with the possible exception of limited user-specific application configuration settings.

Platform as a Service (PaaS): The capability provided to the consumer is to deploy onto the cloud infrastructure consumer-created or acquired applications created using programming languages, libraries, services and tools supported by the provider. The consumer does not manage or control the underlying cloud infrastructure including networks, servers, operating systems or storage, but has control over the deployed applications and possibly configuration settings for the application-hosting environment.

Infrastructure as a Service (IaaS): The capability provided to the consumer is to provision processing, storage, networks and other fundamental computing resources where the consumer is able to deploy and run arbitrary software, which can include operating systems and applications. The consumer does not manage or control the underlying cloud infrastructure but has control over operating systems, storage and deployed applications; and possibly limited control of select networking components (e.g., host firewalls).

Deployment Models are as follows:

Private Cloud: The cloud infrastructure is provisioned for exclusive use by a single organization comprising multiple consumers (e.g., business units). It may be owned, managed and operated by the organization, a third party or some combination of them, and it may exist on or off premises.

Community Cloud: The cloud infrastructure is provisioned for exclusive use by a specific community of consumers from organizations that have shared concerns (e.g., mission, security requirements, policy and compliance considerations). It may be owned, managed and operated by one or more of the organizations in the community, a third party, or some combination of them, and it may exist on or off premises.

Public Cloud: The cloud infrastructure is provisioned for open use by the general public. It may be owned, managed and operated by a business, academic or government organization, or some combination of them. It exists on the premises of the cloud provider.

Hybrid Cloud: The cloud infrastructure is a composition of two or more distinct cloud infrastructures (private, community or public) that remain unique entities, but are bound together by standardized or proprietary technology that enables data and application portability (e.g., cloud bursting for load balancing between clouds).

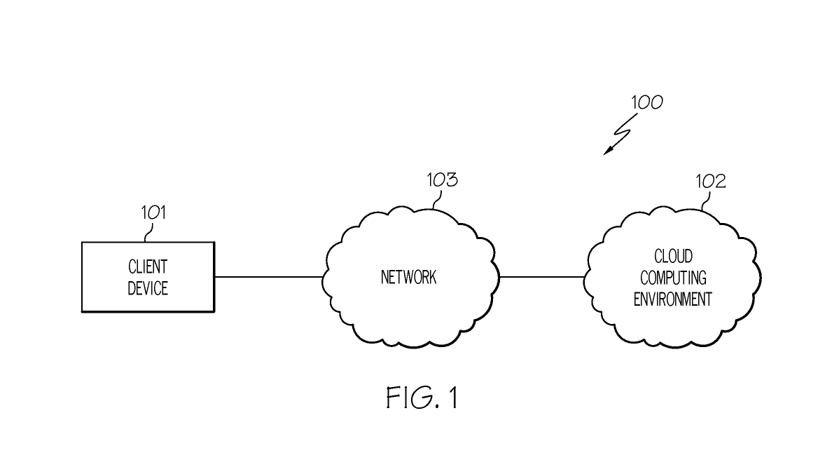

Referring now to the Figures in detail, FIG. 1 illustrates a network system 100 configured in accordance with an embodiment of the present invention. Network system 100 includes a client device 101 connected to a cloud computing environment 102 via a network 103. Client device 101 may be any type of computing device (e.g., portable computing unit, Personal Digital Assistant (PDA), smartphone, laptop computer, mobile phone, navigation device, game console, desktop computer system, workstation, Internet appliance and the like) configured with the capability of connecting to cloud computing environment 102 via network 103.

Network 103 may be, for example, a local area network, a wide area network, a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention.

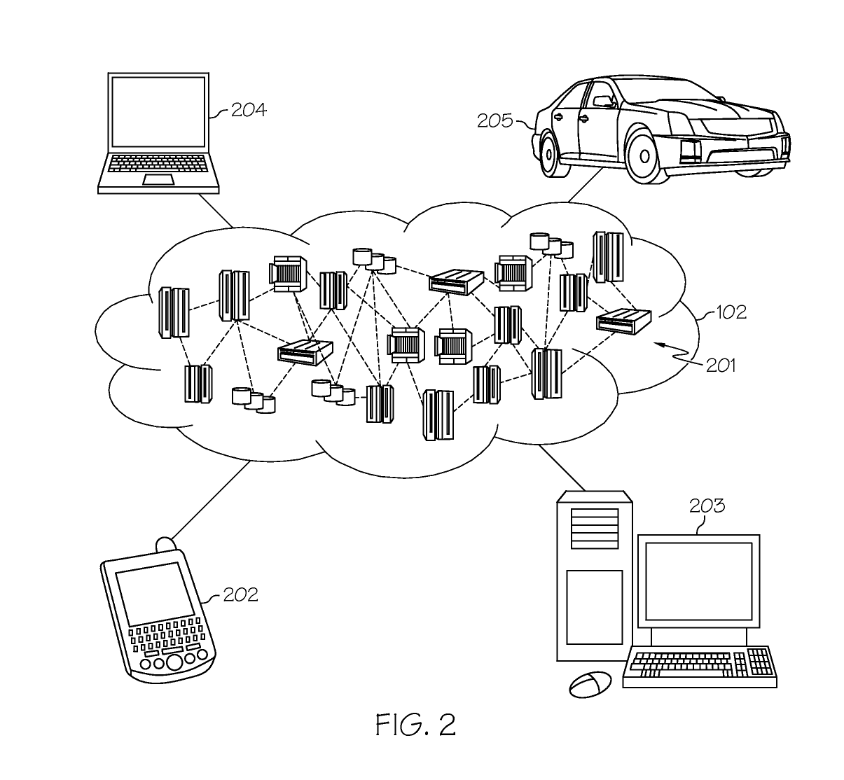

Cloud computing environment 102 is used to deliver computing as a service to client device 101 implementing the model discussed above. An embodiment of cloud computing environment 102 is discussed below in connection with FIG. 2.

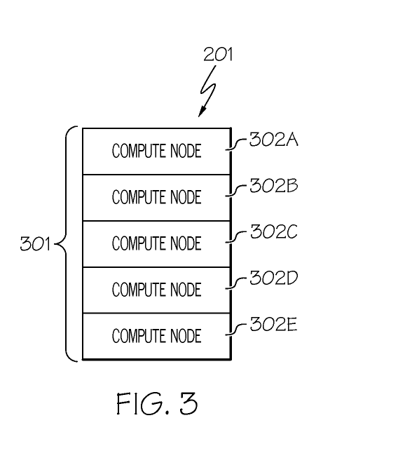

FIG. 2 illustrates cloud computing environment 102 in accordance with an embodiment of the present invention. As shown, cloud computing environment 102 includes one or more cloud computing nodes 201 (also referred to as “clusters”) with which local computing devices used by cloud consumers, such as, for example, Personal Digital Assistant (PDA) or cellular telephone 202, desktop computer 203, laptop computer 204, and/or automobile computer system 205 may communicate. Nodes 201 may communicate with one another. They may be grouped (not shown) physically or virtually, in one or more networks, such as Private, Community, Public, or Hybrid clouds as described hereinabove, or a combination thereof. This allows cloud computing environment 102 to offer infrastructure, platforms and/or software as services for which a cloud consumer does not need to maintain resources on a local computing device. A description of a schematic of exemplary cloud computing nodes 201 is provided below in connection with FIG. 3. It is understood that the types of computing devices 202, 203, 204, 205 shown in FIG. 2, which may represent client device 101 of FIG. 1, are intended to be illustrative and that cloud computing nodes 201 and cloud computing environment 102 can communicate with any type of computerized device over any type of network and/or network addressable connection (e.g., using a web browser). Program code located on one of nodes 201 may be stored on a computer recordable storage medium in one of nodes 201 and downloaded to computing devices 202, 203, 204, 205 over a network for use in these computing devices. For example, a server computer in computing node 201 may store program code on a computer readable storage medium on the server computer. The server computer may download the program code to computing device 202, 203, 204, 205 for use on the computing device.

Referring now to FIG. 3, FIG. 3 illustrates a schematic of a rack of compute nodes (e.g., servers) of a cloud computing node 201 in accordance with an embodiment of the present invention.

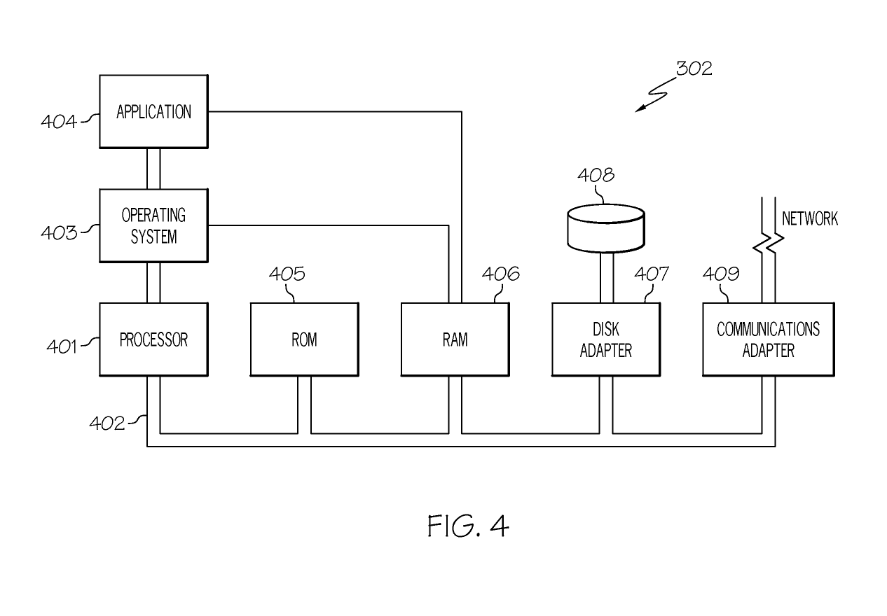

As shown in FIG. 3, cloud computing node 201 may include a rack 301 of hardware components or “compute nodes,” such as servers or other electronic devices. For example, rack 301 houses compute nodes 302A-302E. Compute nodes 302A-302E may collectively or individually be referred to as compute nodes 302 or compute node 302, respectively. An illustration of a hardware configuration of compute node 302 is discussed further below in connection with FIG. 4. FIG. 3 is not to be limited in scope to the number of racks 301 or compute nodes 302 depicted. For example, cloud computing node 201 may be comprised of any number of racks 301 which may house any number of compute nodes 302. Furthermore, while FIG. 3 illustrates rack 301 housing compute nodes 302, rack 301 may house any type of computing component that is used by cloud computing node 201. Furthermore, while the following discusses compute node 302 being confined in a designated rack 301, it is noted for clarity that compute nodes 302 may be distributed across cloud computing environment 102 (FIGS. 1 and 2).

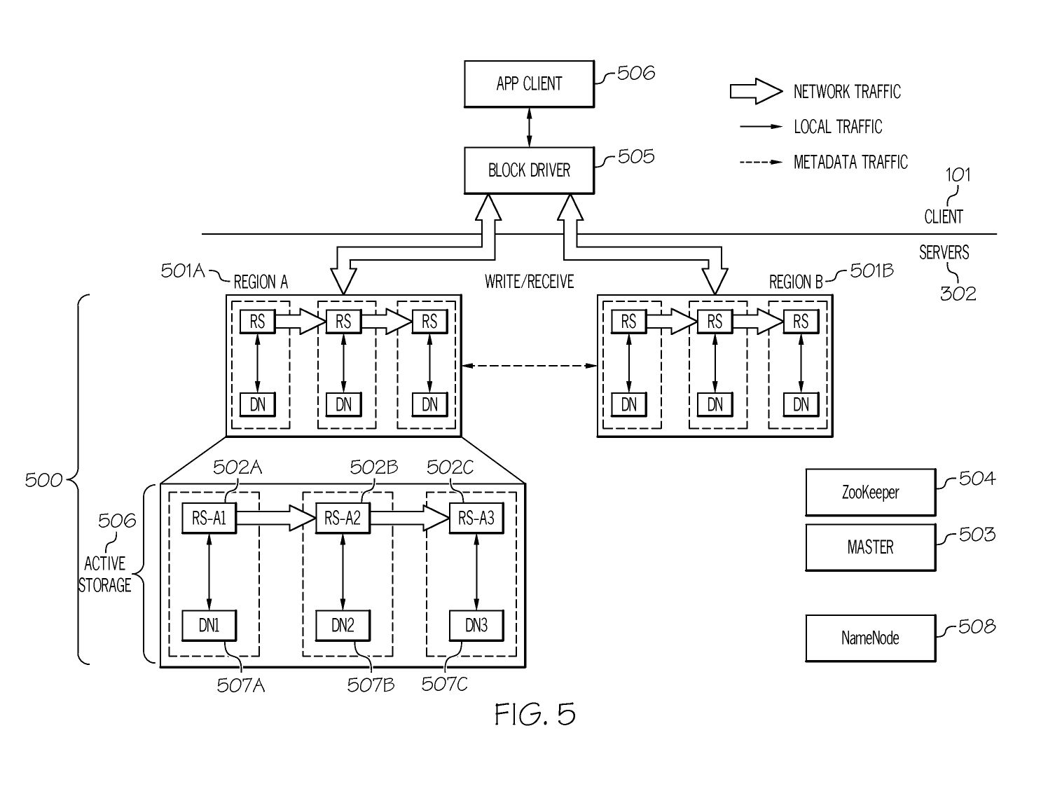

Referring now to FIG. 4, FIG. 4 illustrates a hardware configuration of compute node 302 (FIG. 3) which is representative of a hardware environment for practicing the present invention. Compute node 302 has a processor 401 coupled to various other components by system bus 402. An operating system 403 runs on processor 401 and provides control and coordinates the functions of the various components of FIG. 4. An application 404 in accordance with the principles of the present invention runs in conjunction with operating system 403 and provides calls to operating system 403 where the calls implement the various functions or services to be performed by application 404. Application 404 may include, for example, a program for allowing a storage system, such as a cloud storage system, to accomplish both robustness and scalability while providing end-to-end correctness guarantees for read operations, strict ordering guarantees for write operations, and strong durability and availability guarantees despite a wide range of server failures (including memory corruptions, disk corruptions, firmware bugs, etc.) and scales these guarantees to thousands of machines and tens of thousands of disks as discussed further below in association with FIGS. 5-9.

Referring again to FIG. 4, read-only memory (“ROM”) 405 is coupled to system bus 402 and includes a basic input/output system (“BIOS”) that controls certain basic functions of compute node 302. Random access memory (“RAM”) 406 and disk adapter 407 are also coupled to system bus 402. It should be noted that software components including operating system 403 and application 404 may be loaded into RAM 406, which may be compute node's 302 main memory for execution. Disk adapter 407 may be an integrated drive electronics (“IDE”) adapter that communicates with a disk unit 408, e.g., disk drive.

Compute node 302 may further include a communications adapter 409 coupled to bus 402. Communications adapter 409 interconnects bus 402 with an outside network (e.g., network 103 of FIG. 1).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

As stated in the Background section, currently, storage systems, such as cloud storage systems, have provided end-to-end correctness guarantees on distributed storage despite arbitrary node failures, but these systems are not scalable as they require each correct node to process at least a majority of the updates. Conversely, scalable distributed storage systems typically protect some subsystems, such as disk storage, with redundant data and checksums, but fail to protect the entire path from a client PUT request (request to write data to the storage system) to a client GET request (request to read data from the storage system), leaving them vulnerable to single points of failure that can cause data corruption or loss. Hence, there is not currently a storage system, such as a cloud storage system, that accomplishes both robustness and scalability while providing end-to-end correctness guarantees.

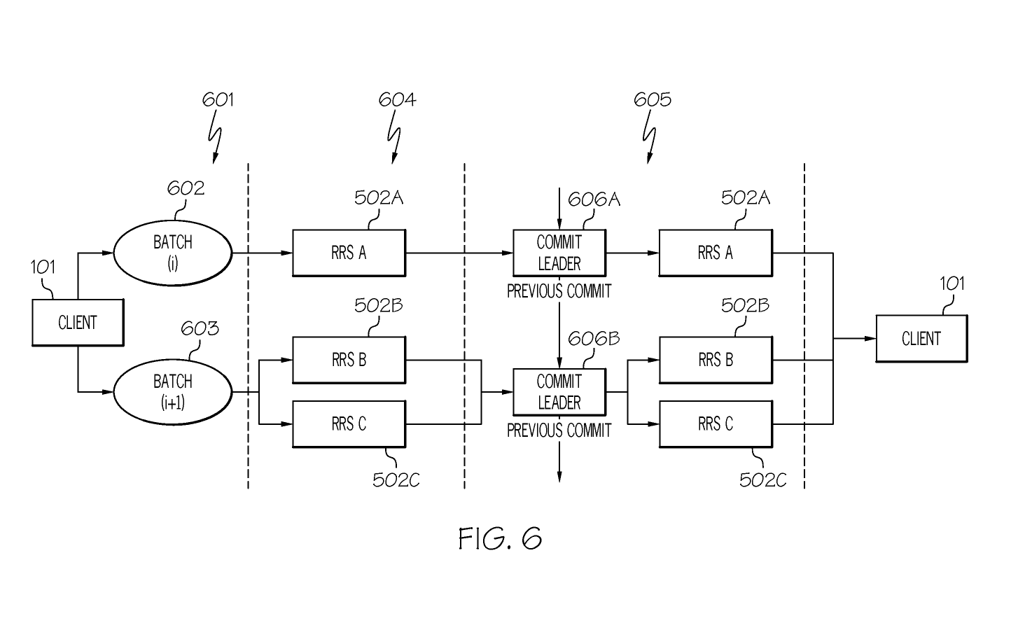

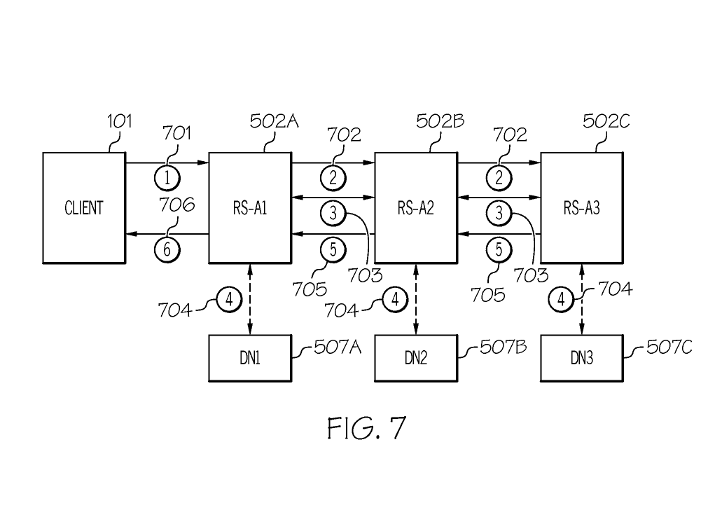

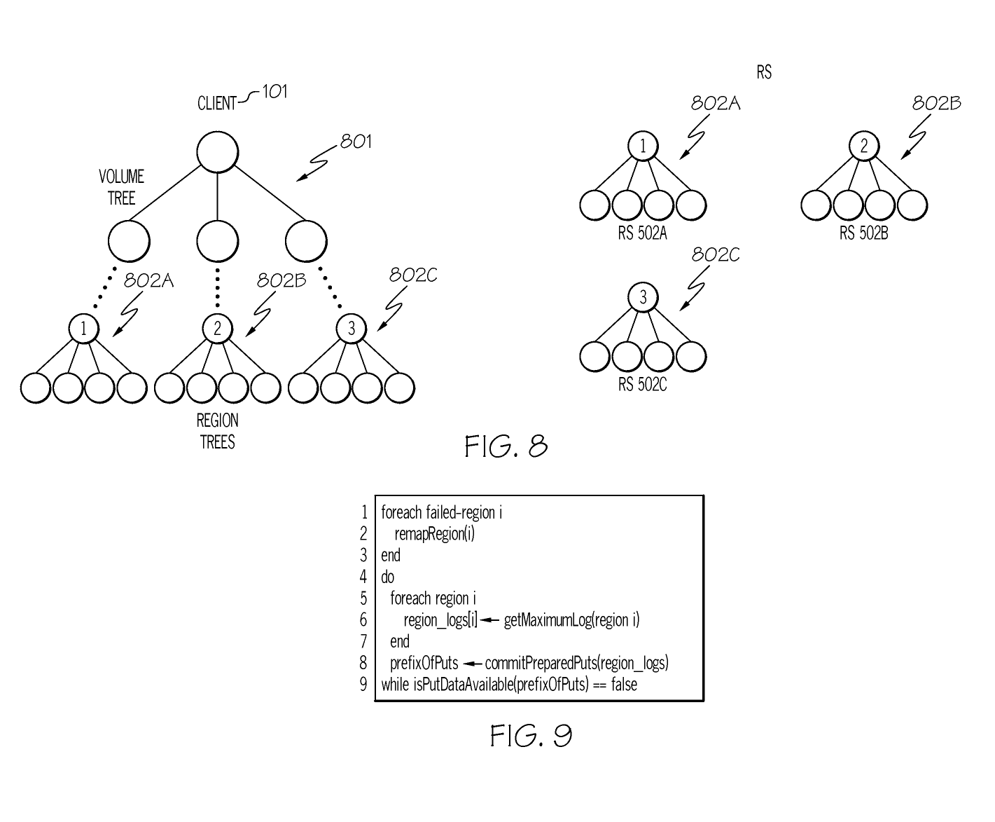

The principles of the present invention provide a storage system, such as a cloud storage system, that accomplishes both robustness and scalability while providing end-to-end correctness guarantees for read operations, strict ordering guarantees for write operations, and strong durability and availability guarantees despite a wide range of server failures (including memory corruptions, disk corruptions, firmware bugs, etc.) and scales these guarantees to thousands of machines and tens of thousands of disks as discussed below in connection with FIGS. 5-9. FIG. 5 illustrates a schematic of a storage system that accomplishes both robustness and scalability. FIG. 6 illustrates the storage system's pipelined commit protocol for write requests. FIG. 7 depicts the steps to process a write request using active storage. FIG. 8 illustrates a volume tree and its region trees. FIG. 9 illustrates the four phases of the recovery protocol in pseudocode.

The storage system of the present invention may be implemented across one or more compute node(s) 302 (FIG. 2). A schematic of such a storage system is discussed below in connection with FIG. 5.

FIG. 5 illustrates a schematic of storage system 500 that accomplishes both robustness and scalability while providing end-to-end correctness guarantees for read operations, strict ordering guarantees for write operations, and strong durability and availability guarantees and scales these guarantees to thousands of machines and tens of thousands of disks in accordance with an embodiment of the present invention.

Referring to FIG. 5, in conjunction with FIGS. 1-4, in one embodiment, storage system 500 uses a Hadoop® Distributed File System (HDFS) layer, partitions key ranges within a table in distinct regions 501A-501B across compute node(s) 302 (e.g., servers as identified in FIG. 5) for load balancing (FIG. 5 illustrates Region A 501A and Region B 501B representing the different regions of blocks of data that are stored by the region servers that are discussed below), and supports the abstraction of a region server 502A-502C (discussed further below) responsible for handling a request for the keys within a region 501A, 501B. Regions 501A-501B may collectively or individually be referred to as regions 501 or region 501, respectively. While storage system 500 illustrates two regions 501A-501B, storage system 500 may include any number of regions 501 and FIG. 5 is not to be limited in scope to the depicted elements.

Blocks of data are mapped to their region server 502A-502C (e.g., logical servers) (identified as “RS-A1,” “RS-A2, and “RS-A3,” respectively, in FIG. 5) through a master node 503, leases are managed using a component referred to herein as the “zookeeper” 504, and clients 101 need to install a block driver 505 to access storage system 500. In one embodiment, zookeeper 504 is a particular open source lock manager/coordination server. By having such an architecture, storage system 500 has the ability to scale to thousands of nodes and tens of thousands of disks. Furthermore, by having such an architecture, storage system 500 achieves its robustness goals (strict ordering guarantees for write operations across multiple disks, end-to-end correctness guarantees for read operations, strong availability and durability guarantees despite arbitrary failures) without perturbing the scalability of prior designs.

As illustrated in FIG. 5, the core of active storage 506 is a three-way replicated region server (RRS) or (RS) 502A-502C, which guarantees safety despite up to two arbitrary server failures. Replicated region servers 502A-502C may collectively or individually be referred to as replicated region servers 502 or replicated region server 502, respectively. While FIG. 5 illustrates active storage 506 being a three-way replicated region, active storage 506 may include any number of replicated region servers 502. Replicated region servers 502 are configured to handle computation involving blocks of data for its region 501 (e.g., region 501A). While FIG. 5 illustrates replicated region servers 502A-502C being associated with region 501A, the replicated region servers associated with region 501B and other regions 501 not depicted are configured similarly. Similarly, end-to-end verification is performed within the architectural feature of block driver 505, though upgraded to support scalable verification mechanisms.

FIG. 5 also helps to describe the role played by the novel techniques of the present invention (pipelined commit, scalable end-to-end verification, and active storage) in the operation of storage system 500. Every client request (request form client 101 is mediated by block driver 505, which exports a virtual disk interface by converting the application's 506 API calls into storage system's 500 GET and PUT requests (GET request is a request to read data from storage system 500 and PUT request is a request to write data to storage system 500). In one embodiment, block driver 505 is in charge of performing storage system's 500 scalable end-to-end verification (discussed later herein). For PUT requests, block driver 505 generates the appropriate metadata, while for GET requests, block driver 505 uses the request's metadata to check whether the data returned to client 101 is consistent.

To issue a request, client 101 (i.e., its block driver 505) contacts master 503, which identifies the RRS 502 responsible for servicing the block that client 101 wants to access. Client 101 caches this information for future use and forwards the request to that RRS 502. The first responsibility of RRS 502 is to ensure that the request commits in the order specified by client 101. This is accomplished, at least in part, via the pipelined commit protocol (discussed later herein) that requires only minimal coordination to enforce dependencies among requests assigned to distinct RRSs 502. If the request is a PUT, RRS 502 also needs to ensure that the data associated with the request is made persistent, despite the possibility of individual region servers 502 suffering commission failures. This is the role of active storage (discussed later herein): the responsibility of processing PUT requests is no longer assigned to a single region server 502, but is instead conditioned on the set of replicated region servers 502 achieving unanimous consent on the update to be performed. Thanks to storage system's 500 end-to-end verification guarantees, GET requests can instead be safely carried out by a single region server 502 (with obvious performance benefits), without running the risk that client 101 sees incorrect data.

In order to build a high-performance block store, storage system 500 allows clients 101 to mount volumes spanning multiple regions 501 and to issue multiple outstanding requests that are executed concurrently across these regions 501. When failures occur, even just crashes, enforcing the order commit property in these volumes can be challenging.

Consider, for example, a client 101 that, after mounting a volume V that spans regions 501A and 501B, first issues a PUT to for a block mapped to region 501A, and then, without waiting for the PUT to complete, issues a barrier PUT u₂ for a block mapped at region 501B. Untimely crashes, even if not permanent, of client 101 and of the region server 502 for region 501A may lead to u₁ being lost even as u₂ commits. Volume V now not only violates both standard disk semantics and the fall back weaker prefix semantics, but it is left in an invalid state, with the potential of suffering further severe data loss. Of course, one simple way to avoid such inconsistencies would be to allow clients 101 to issue one request (or one batch of requests until the barrier) at a time, but performance would suffer significantly.

The purpose of the pipelined commit protocol of the present invention is to allow clients 101 to issue multiple outstanding request/batches and achieve good performance without compromising the ordered-commit property. To achieve this goal, storage system 500 parallelizes the bulk of the processing (such as cryptographic checks or disk-writes to log PUTs) required to process each request, while ensuring that requests commit in order.

Storage system 500 ensures ordered commit by exploiting the sequence number that clients 101 assign to each request. Region servers 502 use these sequence numbers to guarantee that a request does not commit unless the previous request is also guaranteed to eventually commit. Similarly, during recovery, these sequence numbers are used to ensure that a consistent prefix of issued requests is recovered.

Storage system's 500 technique to ensure ordered-commit for GETs is now discussed. A GET request to a region server 502 carries a prevNum field indicating the sequence number of the last PUT executed on that region 501 to prevent returning stale values: region servers 502 do not execute a GET until they have committed a PUT with the prevNum sequence number. Conversely, to prevent the value of a block from being overwritten by a later PUT, clients 101 block PUT requests to a block that has outstanding GET requests.

Storage system's 500 pipelined commit protocol for PUTs is illustrated in FIG. 6 in accordance with an embodiment of the present invention. Referring to FIG. 6, in conjunction with FIGS. 1-5, client 101 issues requests in batches. In one embodiment, each client 101 is allowed to issue multiple outstanding batches and each batch is committed using a 2PC-like protocol, consisting of the phases described below. Compared to 2PC, pipelined commit reduces the overhead of the failure-free case by eliminating the disk write in the commit phase and by pushing complexity to the recovery protocol, which is usually a good trade-off

In phase 601, to process a batch, a client 101 divides its PUTs into various subbatches (e.g., batch (i) 602 and batch (i+1) 603), one per region server 502. Just like a GET request, a PUT request to a region 501 also includes a prevNum field to identify the last PUT request executed at that region 501. Client 101 identifies one region server 502 as leader for the batch and sends each sub-batch to the appropriate region server 502 along with the leader's identity. Client 101 sends the sequence numbers of all requests in the batch to the leader, along with the identity of the leader of the previous batch.

In phase 604, a region server 502 preprocesses the PUTs in its sub-batch by validating each request, i.e. by checking whether it is signed and it is the next request that should be processed by the region server 502 using the prevNum field. If the validation succeeds, region server 502 logs the request and sends its YES vote to this batch's leader; otherwise, region server 502 votes and sends NO.

In phase 605, on receiving a yes vote for all the PUTs in a batch and a COMMIT-CONFIRMATION from the leader 606A, 606B of the previous batch, leader 606A, 606B decides to commit the batch and notify the participants. Leaders 606A, 606B may collectively or individually be referred to as leaders 606 or leader 606, respectively. A region server 502 processes the COMMIT for a request by updating its memory state (memstore) and sending the reply to client 101. At a later time, region server 502 may log the commit to enable the garbage collection of its log. Region server 502 processes the ABORT by discarding the state associated with that PUT and notifying client 101 of the failure.

It is noted that all disk writes—both within a batch and across batches—can proceed in parallel. The voting phase and the commit phase for a given batch are similarly parallelized. Different region servers 502 receive and log the PUT and COMMIT asynchronously. The only serialization point is the passing of COMMIT-CONFIRMATION from leader 606 of a batch to leader 606 of the next batch.

Despite its parallelism, the protocol ensures that requests commit in the order specified by client 101. The presence of COMMIT in any correct region server's 502 log implies that all preceding PUTs in this batch must have been prepared. Furthermore, all requests in preceding batches must have also been prepared. The recovery protocol of the present invention (discussed further below) ensures that all these prepared PUTs eventually commit without violating ordered-commit. The pipelined commit protocol enforces ordered-commit assuming the abstraction of (logical) region servers 502 that are correct. It is the active storage protocol (discussed below) that, from physical region servers 502 that can lose committed data and suffer arbitrary failures, provides this abstraction to the pipelined commit protocol.

Referring to FIG. 5, active storage 506 provides the abstraction of a region server 502 that does not experience arbitrary failures or lose data. Storage system 500 uses active storage 506 to ensure that the data remains available and durable despite arbitrary failures in the storage system by addressing a key limitation of existing scalable storage systems: they replicate data at the storage layer but leave the computation layer unreplicated. As a result, the computation layer that processes clients' 101 requests represents a single point of failure in an otherwise robust system. For example, a bug in computing the checksum of data or a corruption of the memory of a region server 502 can lead to data loss and data unavailability. The design of storage system 500 of the present invention embodies a simple principle: all changes to persistent state should happen with the consent of a quorum of nodes. Storage system 500 uses these compute quorums to protect its data from faults in its region servers 502.

Storage system 500 implements this basic principle using active storage. In addition to storing data, storage nodes (nodes 507A-507C discussed further herein) in storage system 500 also coordinate to attest data and perform checks to ensure that only correct and attested data is being replicated. Ensuring that only correct and attested data is being replicated may be accomplished, at least in part, by having each of the storage nodes 507A-507C (identified as “DN1,” “DN2,” and “DN3,” respectively, in FIG. 5) validate that all of the replicated region servers 502 are unanimous in updating the blocks of data in region 501 prior to updating the blocks of data in region 501 as discussed further herein. Storage nodes 507A-507C may collectively or individually be referred to as storage nodes 507 or storage node 507, respectively. In one embodiment, each region server 502 is associated with a particular storage node 507. For example, region server 502A is associated with storage node 507A. Region server 502B is associated with storage node 507B. Furthermore, region server 502C is associated with storage node 507C. While having region server 502 being associated with a particular storage node 507 is a desirable performance optimization, it is not required. Furthermore, in one embodiment, each region server 502 is co-located with its associated storage node 507, meaning that they are both located on the same compute node 302. Additionally, in one embodiment, region server 502 may read data from any storage node 507 that stores the data to be read. Also, region server 502 may write data to a remote storage node 507 if the local storage node 507 (storage node 507 associated with region server 502) is full or the local disks were busy.

In addition to improving fault-resilience, active storage 506 also enables performance improvement by trading relatively cheap processing unit cycles for expensive network bandwidth. Using active storage 506, storage system 500 can provide strong availability and durability guarantees: a data block with a quorum of size n will remain available and durable as long as no more than n−1 nodes 507 fail. These guarantees hold irrespective of whether nodes 507 fail by crashing (omission) or by corrupting their disk, memory, or logical state (commission).

Replication typically incurs network and storage overheads. Storage system 500 uses two key ideas—(1) moving computation to data, and (2) using unanimous consent quorums—to ensure that active storage 506 does not incur more network cost or storage cost compared to existing approaches that do not replicate computation.

Storage system 500 implements active storage 506 by blurring the boundaries between the storage layer and the compute layer. Existing storage systems require the primary datanode to mediate updates. In contrast, storage system 500 of the present invention modifies the storage system API to permit clients 101 to directly update any replica of a block. Using this modified interface, storage system 500 can efficiently implement active storage 506 by colocating a compute node (region server) 502 with the storage node (datanode) 507 that it needs to access.

Active storage 506 thus reduces bandwidth utilization in exchange for additional processing unit usage—an attractive trade-off for bandwidth starved data-centers. In particular, because region server 502 can now update the collocated datanode 507 without requiring the network, the bandwidth overheads of flushing and compaction, such as used in HBase™ (Hadoop® database), are avoided.

Furthermore, as illustrated in FIG. 5, storage system 500 includes a component referred to herein as the NameNode 508. Region server 502 sends a request to NameNode 508 to create a block, and NameNode 508 responds by sending the location of a new range of blocks. This request is modified to include a location-hint consisting of a list of region servers 502 that will access the block. NameNode 508 assigns the new block at the desired nodes if the assignment does not violate its load-balancing policies; otherwise, it assigns a block satisfying its policies.

Storage system 500 provides for a loose coupling between replicated region server 502 and datanode 507. Loose coupling is selected over tight coupling because it provides better robustness: it allows NameNode 508 to continue to load balance and re-replicate blocks as needed, and it allows a recovering replicated region server 502 to read state from any datanode 507 that stores it, not just its own disk.

To control the replication and storage overheads, unanimous consent quorums for PUTs are used. Existing systems replicate data to three nodes to ensure durability despite two permanent omission failures. Storage system 500 provides the same durability and availability guarantees despite two failures of either omission or commission without increasing the number of replicas. To achieve that, requires the replicas 502 to reach unanimous consent prior to performing any operation that changes state, ensuring that if need be any replica 502 can safely be used to rebuild the system state.

Of course, the failure of any of the replicated region servers 502 can prevent unanimous consent. To ensure liveness, storage system 500 replaces any RRS 502 that is not making adequate progress with a new set of region servers 502, which read all state committed by the previous region server quorum from datanodes 507 and resume processing requests. If client 101 detects a problem with a RRS 502, it sends a RRS-replacement request to master 503, which first attempts to get all the nodes of the existing RRS 502 to relinquish their leases; if that fails, master 503 coordinates with zookeeper 504 to prevent lease renewal. Once the previous RRS 502 is known to be disabled, master 503 appoints a new RRS 502. Storage system 500 performs the recovery protocol as described further below.

It is now discussed how unanimous consent and the principle of moving the computation to the data affect storage system's 500 protocol for processing PUT requests and performing flushing and compaction.

The active storage protocol is run by the replicas of a RRS 502, which are organized in a chain. The primary region server (the first replica in the chain, such as RRS 502A) issues a proposal, based either on a client's PUT request or on a periodic task (such as flushing and compaction). The proposal is forwarded to all replicated region servers 502 in the chain. After executing the request, the region servers 502 coordinate to create a certificate attesting that all replicas in the RRS 502 executed the request in the same order and obtained identical responses.

All other components of storage system 500 (NameNode 508, master 503) as well as client 101) use the active storage 506 as a module for making data persistent and will accept a message from a RRS 502 when it is accompanied by such a certificate. This guarantees correctness as long as there is one replicated region server 502 and its corresponding datanode 507 that do not experience a commission failure.

FIG. 7 depicts the steps to process a PUT request using active storage in accordance with an embodiment of the present invention. Referring to FIG. 7, in conjunction with FIGS. 1-5, to process a PUT request (step 701), region servers 502 validate the request, agree on the location and order of the PUT in the append-only logs (steps 702, 703) and create a PUT-log certificate that attests to that location and order. Each replicated region server 502 sends the PUT and the certificate to its corresponding datanode 507 to guarantee their persistence and waits for the datanode's 507 confirmation (step 704), marking the request as prepared. Each replicated region server 502 independently contacts the commit leader and waits for the COMMIT as described in the pipelined commit protocol. On receiving the COMMIT, replicated region servers 502 mark the request as committed, update their in-memory state and generate a PUT-ack certificate for client 101. Conversely, on receiving an ABORT, replicated region servers 502 generate a PUT-nack certificate and send it to client 101.

The logic for flushing and compaction is replicated in a similar manner, with the difference that these tasks are initiated by the primary region server (one of the region servers 502 designated as the “primary” region server) and other replicated region servers 502 verify if it is an appropriate time to perform these operations based on predefined deterministic criteria, such as the current size of the memstore.

Local file systems fail in unpredictable ways. To provide strong correctness guarantees despite these failures, storage system 500 implements end-to-end checks that allow client 101 to ensure that it accesses correct and current data. Importantly, end-to-end checks allow storage system 500 to improve robustness for GETs without affecting performance: they allow GETs to be processed at a single replica and yet retain the ability to identify whether the returned data is correct and current.

Like many existing systems, storage system 500 implements end-to-end checks using Merkle trees as they enable incremental computation of a hash of the state. Specifically, client 101 maintains a Merkle tree, called a volume tree, on the blocks of the volume it accesses. This volume tree is updated on every PUT and verified on every GET. Storage system's 500 implementation of this approach is guided by its goals of robustness and scalability.

For robustness, storage system 500 does not rely on client 101 to never lose its volume tree. Instead, storage system 500 allows a client 101 to maintain a subset of its volume tree and fetch the remaining part from region servers 502 serving its volume on demand. Furthermore, if a crash causes a client 101 to lose its volume tree, client 101 can rebuild the tree by contacting region servers 502 responsible for regions 501 in that volume. To support both these goals efficiently, storage system 500 requires that the volume tree is also stored at the region servers 502 that host the volume.

A volume can span multiple region servers 502, so for scalability and load-balancing, each region server 502 only stores and validates a region tree for the regions 501 that it hosts. The region tree is a sub-tree of the volume tree corresponding to the blocks in a given region. In addition, to enable client 101 to recover the volume tree, each region server 502 also stores the latest known root hash and an associated sequence number provided by client 101.

FIG. 8 illustrates a volume tree 801 and its region trees 802A-802C (for region servers 502A-502C, respectively) in accordance with an embodiment of the present invention. Region trees 802A-802C may collectively or individually be referred to as region trees 802 or region tree 802, respectively. While FIG. 8 illustrates three region trees 802, volume tree 801 may be associated with any number of region trees 802 corresponding to the number of region servers 502 servicing that region 501.

Referring to FIG. 8, in conjunction with FIGS. 1-5, client 101 stores the top levels of the volume tree 801 that are not included in any region tree 802 so that it can easily fetch the desired region tree 802 on demand. Client 101 can also cache recently used region trees 802 for faster access.

To process a GET request for a block, client 101 sends the request to any of the region servers 502 hosting that block. On receiving a response, client 101 verifies it using the locally stored volume tree 801. If the check fails (due to a commission failure) or if the client 101 times out (due to an omission failure), client 101 retries the GET using another region server 502. If the GET fails at all region servers 502, client 101 contacts master 503 triggering the recovery protocol (discussed further below). To process a PUT, client 101 updates its volume tree 801 and sends the weakly-signed root hash of its updated volume tree 801 along with the PUT request to the RRS 502. Attaching the root hash of the volume tree 801 to each PUT request enables clients 101 to ensure that, despite commission failures, they will be able to mount and access a consistent volume.

A client's protocol to mount a volume after losing volume tree 801 is simple. Client 101 begins by fetching the region trees 802, the root hashes, and the corresponding sequence numbers from the various RRSs 502. Before responding to a client's fetch request, a RRS 502 commits any prepared PUTs pending to be committed using the commit-recovery phase of the recovery protocol (discussed further below). Using the sequence numbers received from all the RRSs 502 client 101 identifies the most recent root hash and compares it with the root hash of the volume tree constructed by combining the various region trees 802. If the two hashes match, client 101 considers the mount to be complete; otherwise it reports an error indicating that a RRS 502 is returning a potentially stale tree. In such cases, client 101 reports an error to master 503 to trigger the replacement of the corresponding replicated region servers 502, as described further below.

Storage system 500 end-to-end checks enforce its freshness property while the recovery protocol (discussed further below) ensures liveness.

Storage system's 500 recovery protocol handles region server 502 and datanode 507 failures. Storage system 500 repairs failed region servers 502 to enable liveness through unanimous consent and repairs failed datanodes 507 to ensure durability.

The goal of recovery is to ensure that, despite failures, the volume's state remains consistent. In particular, storage system 500 tries to identify the maximum prefix PC of committed PUT requests that satisfy the ordered-commit property and whose data is available. It is noted that if a correct replica is available for each of the volume's regions, PC is guaranteed to contain all PUT requests that were committed to the volume, thereby satisfying standard disk semantics. If no correct replica is available for some region, and some replicas of that region suffer commission failures, PC is not guaranteed to contain all committed PUT requests, but may instead contain only a prefix of the requests that satisfies the ordered-commit property, thereby providing the weaker prefix semantics. To achieve its goal, recovery addresses three key issues.

Resolving log discrepancies: Because of omission or commission failures, replicas of a log (or simply referred to as a “replica”) at different datanodes 507 may have different contents. A prepared PUT, for example, may have been made persistent at one datanode 507, but not at another datanode 507. To address such discrepancies, storage system 500 identifies the longest available prefix of the log, as described below.

Identifying committable requests: Because COMMITs are sent and logged asynchronously, some committed PUTs may not be marked as such. It is possible, for example, that a later PUT is marked committed but an earlier PUT is not. Alternatively, it is possible that a suffix of PUTs for which client 101 has received an ack (acknowledge) are not committed. By combining the information from the logs of all regions in the volume, storage system 500 commits as many of these PUTs as possible, without violating the ordered-commit property. This defines a candidate prefix: an ordered-commit-consistent prefix of PUTs that were issued to this volume.

Ensuring durability: If no correct replica is available for some region 501, then it is possible that the data for some PUTs in the candidate prefix is not available. If so, recovery waits until a replica containing the missing data becomes available.

FIG. 9 illustrates the four phases of the recovery protocol in pseudocode in accordance with an embodiment of the present invention. Referring to FIG. 9, in conjunction with FIGS. 1-5 and 8, storage system 500 uses the same protocol to recover from both datanode 507 failures and the failures of the region servers 502.

1. Remap phase (remapRegion). When a RRS 502 crashes or is reported to not make progress by client 101, master 503 swaps out the RRSs 502 and assigns its regions to one or more replacement RRSs 502.

2. Log-recovery phase (getMaximumLog). In this phase, the new region servers 502 assigned to a failed region 501 choose an appropriate log to recover the state of the failed region 501. Because there are three copies of each log (one at each datanode 507), RRSs 502 decide which copy to use. In one embodiment, RRS 502 decides which copy to use by starting with the longest log copy and iterating over the next longest log copy until a valid log is found. A log is valid if it contains a prefix of PUT requests issued to that region 501. A PUT-log certificate attached to each PUT record is used to separate valid logs from invalid ones. Each region server 502 independently replays the log and checks if each PUT record's location and order matches the location and order included in that PUT record's PUT-log certificate; if the two sets of fields match, the log is valid, otherwise not. Having found a valid log, RRSs 502 agree on the longest prefix and advance to the next stage.

3. Commit-recovery phase (commitPreparedPuts). In this phase, RRSs 502 use the sequence number attached to each PUT request to commit prepared PUTs and to identify an ordered-commit-consistent candidate prefix. In one embodiment, the policy for committing prepared PUTs is as follows: a prepared PUT is committed if (a) a later PUT, as determined by the volume's sequence number, has committed, or (b) all previous PUTs since the last committed PUT have been prepared. The former condition enables to ensure ordered-commit while the latter condition ensures durability by guaranteeing that any request for which client 101 has received a commit will eventually commit. The maximum sequence number of a committed PUT identifies the candidate prefix.

The following approached is implemented. Master 503 asks the RRSs 502 to report their most recent committed sequence number and the list of prepared sequence numbers. Region servers 502 respond to master's 503 request by logging the requested information to a known file in zookeeper 504. Each region server 502 downloads this file to determine the maximum committed sequence number and uses this sequence number to commit all the prepared PUTs that can be committed as describe above. This sequence number (and associated root hash) of the maximum committed PUT is persistently stored in zookeeper 504 to indicate the candidate prefix.

4. Data-recovery phase (isPutDataAvailable). In this phase, master 503 checks if the data for the PUTs included in the candidate prefix is available or not. The specific checks master 503 performs are identical to the checks performed by client 101 in the mount protocol (discussed above) to determine if a consistent volume is available: master 503 requests the recent region trees 802 from all the RRSs 502 to which the RRSs 502 respond using unanimous consent. Using the replies, master 503 compares the root hash computed in the commit-recovery phase with the root hash of the fetched region trees 802. If the two hashes match, the recovery is considered completed. If not, a stale log copy is chosen in the log-recovery phase, and the earlier phases are repeated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A storage system, comprising:
a plurality of replicated region servers configured to handle computation involving blocks of data in a region; and
a plurality of storage nodes configured to store said blocks of data in said region, wherein each of said plurality of replicated region servers is associated with a particular storage node of said plurality of storage nodes, where each of said storage nodes is configured to validate that all of said plurality of replicated region servers are unanimous in updating said blocks of data in said region prior to updating said blocks of data in said region.

2. The storage system as recited in claim 1, wherein each of said plurality of replicated region servers is co-located with its associated storage node.

3. The storage system as recited in claim 1, wherein a first region server of said plurality of replicated region servers receives a read request from a client for reading a block of data from said region, wherein said read request comprises a field storing a sequence number, wherein said first region server executes said read request in response to all of said plurality of replicated region servers committing a write request to write a block of data to said region containing a field storing said sequence number.

4. The storage system as recited in claim 1, wherein a first region server of said plurality of replicated region servers receives a write request from a client to write a block of data to said region, wherein said write request comprises a field storing a sequence number of a last write request executed at said region to write a block of data to said region, wherein said first region server is configured to preprocess said write request by validating said write request by checking whether said write request is signed and it is a next request that should be processed by said first region server of said plurality of replicated region servers using said sequence number.

5. The storage system as recited in claim 4, wherein said first region server of said plurality of replicated region servers is configured to log said write request in response to a successful validation.

6. The storage system as recited in claim 4, wherein said first region server of said plurality of replicated region servers is configured to inform one of said plurality of replicated region servers designated as a leader a success or a lack of success in said validation.

7. The storage system as recited in claim 4, wherein said write request is received as part of a batch of write requests.

8. The storage system as recited in claim 1, wherein each of said plurality of replicated region servers maintains a subset of a volume tree for blocks of data in a volume that each of said plurality of replicated region servers host, wherein a remaining portion of said volume tree is maintained by a client.

9. The storage system as recited in claim 8, wherein said volume tree is updated on every request to write a block of data in said volume.

10. The storage system as recited in claim 8, wherein said volume tree is verified on every request to read a block of data in said volume.

11. The storage system as recited in claim 8, wherein each of said plurality of replicated region servers stores a latest known root hash and an associated sequence number provided by a client.

12. The storage system as recited in claim 8, wherein a first region server of said plurality of replicated region servers verifies a request to read a block of data in said volume issued from said client using its maintained volume tree.

13. The storage system as recited in claim 8, wherein a first region server of said plurality of replicated region servers receives a root hash of said volume tree attached to a request to write a block of data in said volume.

14. The storage system as recited in claim 1 further comprises:
a master node configured to replace said plurality of replicated region servers with a second plurality of replicated region servers in response to a failure of a first region server of said plurality of replicated region servers in said region.

15. The storage system as recited in claim 14, wherein each of said plurality of storage nodes stores a copy of a log, wherein said second plurality of replicated region servers select a log from copies of logs stored in said plurality of storage nodes to recover a state of said failed region by starting with a longest log copy and iterating over a next longest log copy until a valid log is found.

16. The storage system as recited in claim 15, wherein said selected log is valid if it contains a prefix of write requests issued to said region.

17. The storage system as recited in claim 1, wherein said storage system resides in a cloud computing node of a cloud computing environment.
